(19) United States
(12) Patent Application Publication
(10) Pub. No.: US 2024/0379308 A1
(43) Pub. Date: Nov. 14, 2024

(54) BACKLIGHT KEYSWITCH

(71) Applicant: Darfon Electronics Corp., Taoyuan City (TW)

(72) Inventors: Chih-Hung Chien, Taoyuan City (TW); Chih-Chung Yen, Taoyuan City (TW)

(73) Assignee: Darfon Electronics Corp., Taoyuan City (TW)

(21) Appl. No.: 18/644,074

(22) Filed: Apr. 23, 2024

(30) Foreign Application Priority Data
May 12, 2023 (TW) 112117712

(51) Int. Cl. H01H 13/7073; H01H 13/02

(52) U.S. Cl. CPC H01H 13/7073; H01H 13/023; H01H 2213/002

(57) ABSTRACT

A backlight keyswitch includes a keyswitch body, a membrane circuit board disposed under the keyswitch body, a backlight module and an elastic body having a bridge structure, a central pillar, and a ring-shaped base disposed on the membrane circuit board. The keyswitch body has a keycap with a symbol. The backlight module is disposed under the membrane circuit board for emitting light to the symbol. The elastic body is disposed between the keycap and the membrane circuit board for returning the keycap to its original position. The bridge structure extends from the ring-shaped base toward the keycap to connect to the central pillar for supporting the central pillar, such that the central pillar is suspended relative to the membrane circuit board and abuts against the keycap. A projection of the central pillar on the keycap completely covers the symbol.

### BACKGROUND OF THE INVENTION

### 1. Field of the Invention

The present invention relates to a backlight keyswitch, and more specifically, to a backlight keyswitch with a projection of an elastic body completely covering a symbol or to a backlight keyswitch having an elastic body abutting against a position on a keycap outside a symbol.

### 2. Description of the Prior Art

In general, for providing a keyboard with a keyswitch lighting function, a common design involves disposing a lighting board with a plurality of backlight sources respectively corresponding to each keyswitch under a bottom board of the keyboard. Accordingly, light emitted by the backlight source can be incident to a corresponding symbol on a keycap via a through hole of the bottom board for generating a symbol lighting effect. In practical applications, an elastic body is usually disposed between the keycap and the backlight source to connect to the keycap and a membrane circuit board. In such a manner, when the keycap is pressed, the elastic body deforms to press and trigger a switch on the membrane circuit board, thereby generating a corresponding keyswitch signal. In addition, an elastic force provided by the elastic body can also return the keycap back to its original position for a user to execute subsequent pressing operations.

However, since light emitted upward by the backlight source must pass through an area where the elastic body is connected to the keycap before being emitted from the symbol, and the area usually has a certain structural thickness, it often results in poor light transmittance and corresponding internal shadows within a light-emitting region of the symbol, thereby causing uneven lighting of the symbol and affecting the visual effect during use.

### SUMMARY OF THE INVENTION

The present invention provides a backlight keyswitch including a keyswitch body, a membrane circuit board, a backlight module, and an elastic body. The keyswitch body has a keycap with a symbol. The membrane circuit board is disposed under the keyswitch body. The backlight module is disposed under the membrane circuit board for emitting light to the symbol via the membrane circuit board. The elastic body is disposed between the keycap and the membrane circuit board for returning the keycap to its original position. The elastic body has a ring-shaped base, a bridge structure, and a central pillar. The ring-shaped base is disposed on the membrane circuit board. The bridge structure extends from the ring-shaped base toward the keycap to connect to the central pillar for supporting the central pillar, to make the central pillar suspended relative to the membrane circuit board and abut against the keycap. A projection of the central pillar on the keycap completely covers the symbol.

The present invention further provides a backlight keyswitch including a keyswitch body, a membrane circuit board, a backlight module, and an elastic body. The keyswitch body has a keycap with a symbol. The membrane circuit board is disposed under the keyswitch body. The backlight module is disposed under the membrane circuit board for emitting light to the symbol via the membrane circuit board. The elastic body is disposed between the keycap and the membrane circuit board for returning the keycap to its original position. The elastic body has a first ring-shaped base, a second ring-shaped base, and a central pillar. The first ring-shaped base abuts against a position on the keycap outside the symbol and forms a first bridge structure extending to connect to the second ring-shaped base. The second ring-shaped base is disposed on the membrane circuit board and forms a second bridge structure extending to connect to the central pillar, to make the central pillar suspended relative to the membrane circuit board.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional diagram of a backlight keyswitch according to an embodiment of the present invention.

FIG. 2 is a diagram of an elastic body in FIG. 1.

FIG. 3 is a diagram of the elastic body in FIG. 2 from another viewing angle.

FIG. 4 is a cross-sectional diagram of a backlight keyswitch according to another embodiment of the present invention.

### DETAILED DESCRIPTION

The present invention will now be described more specifically with reference to the following embodiments. The advantages and spirit of the invention can be further understood in view of the detailed descriptions and the accompanying drawings. The present invention can be implemented or applied to other different embodiments. Certain aspects of the present invention are not limited by the particular details of the examples illustrated herein. Without departing from the spirit and scope of the invention, the present invention will have other modifications and changes. It should be understood that the appended drawings are not necessarily drawn to scale and the configuration of each component (e.g., the size of an elastic body, the number, forming positions, and sizes of keycap symbols and holes) in the drawings is merely illustrative, not presenting an actual condition of the embodiments.

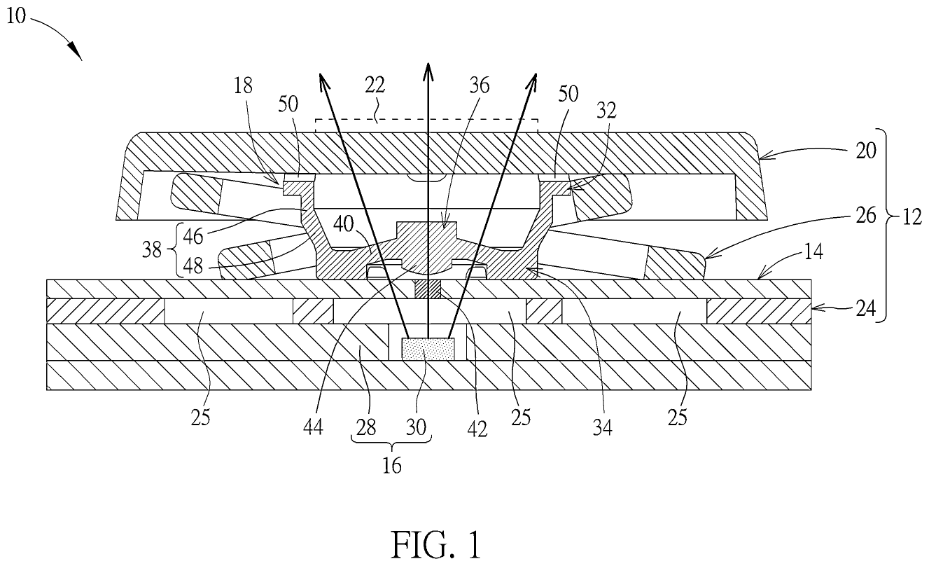

Please refer to FIG. 1, which is a cross-sectional diagram of a backlight keyswitch 10 according to an embodiment of the present invention. The backlight keyswitch 10 could be preferably applied to a foldable electronic apparatus composed of an upper cover and a lower casing or an electronic apparatus having a keyswitch input function (e.g., a notebook or a keyboard device, but not limited thereto). The backlight keyswitch 10 can provide a symbol lighting function such that a user can press the backlight keyswitch 10 conveniently to perform a desired input function. As shown in FIG. 1, the backlight keyswitch 10 includes a keyswitch body 12, a membrane circuit board 14, a backlight module 16, and an elastic body 18. The keyswitch body 12 has a keycap 20 with a symbol 22 (indicated by dashed lines in FIG. 1 and preferably located in a middle position of the keycap 20, but not limited thereto). As for the related description for other components of the keyswitch body 12, it is commonly seen in the prior art. For example, the keyswitch body 12 could further include a bottom board 24 and a lifting mechanism 26 (but not limited thereto). The bottom board 24 is disposed under the keycap 20 and could have at least one hole 25 (three shown in FIG. 1, but the number, forming positions, and size of holes are not limited thereto) to allow light to pass therethrough. The lifting mechanism 26 (e.g., a scissor-type lifting mechanism, but not limited thereto) is movably disposed on the bottom board 24 and connected to the keycap 20 for supporting the keycap 20 to move upward and downward, such that a user can perform input operations. The membrane circuit board 14 is disposed under the keyswitch body 12, and the backlight module 16 (preferably adopting a direct backlight configuration, as exemplified in FIG. 1 by the backlight module 16 including a light guide plate 28 and a backlight source 30 (e.g., an LED) contained within the light guide plate 28, but not limited thereto) is disposed under the membrane circuit board 14. Thus, light emitted upward by the backlight module 16 can pass through the membrane circuit board 14 to the symbol 22 by optical guidance of the light guide plate 28, thereby generating a symbol lighting effect.

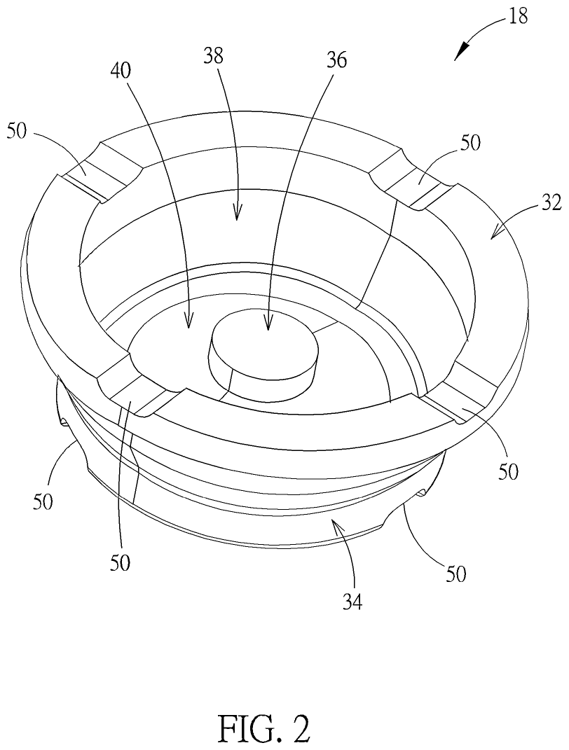

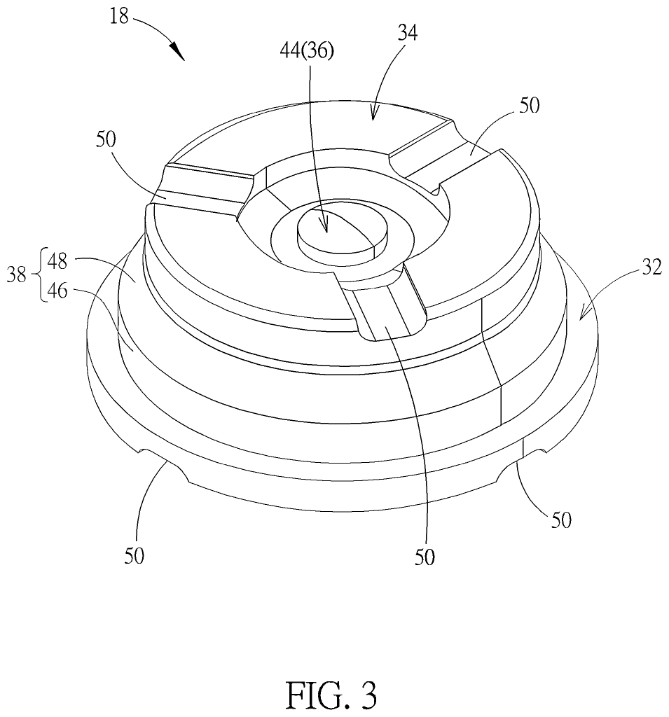

More detailed description for the structural design of the elastic body 18 is provided as follows. Please refer to FIGS. 1, 2, and 3. FIG. 2 is a diagram of the elastic body 18 in FIG. 1. FIG. 3 is a diagram of the elastic body 18 in FIG. 2 from another viewing angle. As shown in FIGS. 1, 2, and 3, the elastic body 18 is disposed between the keycap 20 and the membrane circuit board 14 to provide an elastic force to return the keycap 20 to its original position. The elastic body 18 includes a first ring-shaped base 32, a second ring-shaped base 34, and a central pillar 36. The first ring-shaped base 32 abuts against the keycap 20 at a position outside the symbol 22 (as shown in FIG. 1) and forms a first bridge structure 38 extending to connect to the second ring-shaped base 34. The second ring-shaped base 34 is disposed on the membrane circuit board 14 and forms a second bridge structure 40 extending to connect to the central pillar 36, so as to make the central pillar 36 suspended relative to the membrane circuit board 14.

In addition, the present invention could further adopt a design in which the elastic body is utilized to trigger a switch. For example, as shown in FIG. 1, the membrane circuit board 14 could have a switch 42 (e.g., a membrane switch, but not limited thereto), and the central pillar 36 could have a downward protruding pillar 44 corresponding to the switch 42. Via the aforesaid design, when the keycap 20 is pressed by an external force, the first bridge structure 38 and the second bridge structure 40 of the elastic body 18 are compressed to deform for causing the downward protruding pillar 44 to press and trigger the switch 42, thereby generating a corresponding keyswitch signal. Accordingly, the backlight keyswitch 10 can perform an input function desired by the user. On the other hand, when the external force is released, the elastic body 18 provides an elastic force to return the keycap 20 to an unpressed position, thereby allowing the keycap 20 to automatically return to its original position.

In practical applications, as shown in FIGS. 1 and 3, the first bridge structure 38 could preferably have a vertical bridge portion 46 and an inclined bridge portion 48. The vertical bridge portion 46 extends vertically downward from the first ring-shaped base 32, and the inclined bridge portion 48 extends obliquely from the vertical bridge portion 46 to connect to the second ring-shaped base 34. In such a manner, a pressing force applied to the keycap 20 can be more smoothly transmitted to the elastic body 18 through the vertical structural design of the vertical bridge portion 46 and the oblique connection design of the inclined bridge portion 48, so as to cause corresponding deformation of the elastic body 18. Thus, the triggering sensitivity of the backlight keyswitch 10 can be enhanced. In addition, the second ring-shaped base 34 could preferably have at least one air escape hole 50 (three shown in FIG. 3, but not limited thereto). Accordingly, when the keycap 20 is pressed to cause deformation of the second bridge structure 40, air inside the second ring-shaped base 34 can be expelled through the air escape hole 50 to the outside of the elastic body 18, so as to prevent elasticity of the elastic body 18 from being affected by the air. To be noted, the aforesaid air escape hole could also be applied to the first ring-shaped base 32. As shown in FIG. 2, the first ring-shaped base 32 could have four air escape holes 50, but the present invention is not limited thereto.

In such a manner, via the design in which the first ring-shaped base 32 abuts against the keycap 20 at the position outside the symbol 22 as shown in FIG. 1, the light emitted upward by the backlight module 16 can be directly emitted from the symbol 22 without passing through a position where the elastic body 18 is connected to the keycap 20 (i.e., the position where the first ring-shaped base 32 abuts against the keycap 20 as shown in FIG. 1). Therefore, the present invention can efficiently solve the uneven symbol lighting problem as mentioned in the prior art, in which the light emitted upward by the backlight source must be emitted from the symbol through the area where the elastic body is connected to the keycap to result in poor light transmittance and corresponding internal shadows within the light-emitting region of the symbol. As such, the present invention can greatly improve the lighting uniformity and the visual effect of the keyswitch during use.

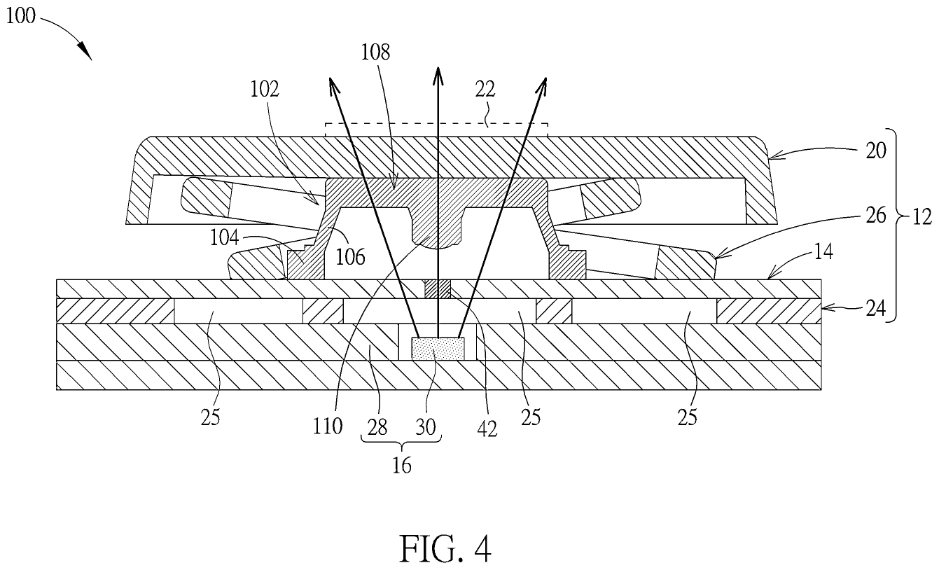

It should be mentioned that the structural design of the elastic body is not limited to the aforesaid embodiment. For example, please refer to FIG. 4, which is a cross-sectional diagram of a backlight keyswitch 100 according to another embodiment of the present invention. Components both mentioned in this embodiment and the aforesaid embodiment represent components with the same or similar structures and functions, and the related description is omitted herein. As shown in FIG. 4, the backlight keyswitch 100 includes the keyswitch body 12, the membrane circuit board 14, the backlight module 16, and an elastic body 102. The elastic body 102 is disposed between the keycap 20 and the membrane circuit board 14 to provide an elastic force to return the keycap 20 to its original position. In this embodiment, the elastic body 102 includes a ring-shaped base 104, a bridge structure 106, and a central pillar 108. The ring-shaped base 104 is disposed on the membrane circuit board 14. The bridge structure 106 extends from the ring-shaped base 104 toward the keycap 20 to connect to the central pillar 108 for supporting the central pillar 108, allowing the central pillar 108 to be suspended relative to the membrane circuit board 14 and abut against the keycap 20 and making a projection of the central pillar 108 on the keycap 20 completely cover the symbol 22. In addition, the present invention could further adopt a design in which the elastic body is utilized to trigger a switch. For example, as shown in FIG. 4, the membrane circuit board 14 could have the switch 42 (e.g., a membrane switch, but not limited thereto), and the central pillar 108 could have a downward protruding pillar 110 corresponding to the switch 42. Via the aforesaid design, when the keycap 20 is pressed by an external force, the bridge structure 106 of the elastic body 102 is compressed to deform for causing the downward protruding pillar 110 to press and trigger the switch 42, thereby generating a corresponding keyswitch signal. Accordingly, the backlight keyswitch 100 can perform an input function desired by the user. On the other hand, when the external force is released, the elastic body 102 provides an elastic force to return the keycap 20 to an unpressed position, thereby allowing the keycap 20 to automatically return to its original position. As for other structural designs (e.g., the air escape hole design) of the backlight keyswitch 100, the related description could be reasoned by analogy according to the aforesaid embodiment and omitted herein.

In such a manner, via the design in which the projection of the central pillar 108 on the keycap 20 completely covers the symbol 22 as shown in FIG. 4, a uniform lighting effect is achieved since the projection of the elastic body 102 completely covers the symbol 22 to ensure that all the light emitted from the symbol 22 must pass through the elastic body 102. Therefore, the present invention can efficiently solve the uneven symbol lighting problem caused by corresponding internal shadows within the light-emitting region of the symbol as mentioned in the prior art. As such, the present invention can greatly improve the lighting uniformity and the visual effect of the keyswitch during use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight keyswitch comprising:
a keyswitch body having a keycap with a symbol;
a membrane circuit board disposed under the keyswitch body;
a backlight module disposed under the membrane circuit board for emitting light to the symbol via the membrane circuit board; and
an elastic body disposed between the keycap and the membrane circuit board for returning the keycap to its original position, the elastic body having a ring-shaped base, a bridge structure, and a central pillar, the ring-shaped base being disposed on the membrane circuit board, the bridge structure extending from the ring-shaped base toward the keycap to connect to the central pillar for supporting the central pillar, to make the central pillar suspended relative to the membrane circuit board and abut against the keycap, and a projection of the central pillar on the keycap completely covering the symbol.

2. The backlight keyswitch of claim 1, wherein the membrane circuit board has a switch, and the central pillar has a downward protruding pillar corresponding to the switch; when the keycap is pressed, the bridge structure deforms to make the downward protruding pillar press and trigger the switch.

3. A backlight keyswitch comprising:
a keyswitch body having a keycap with a symbol;
a membrane circuit board disposed under the keyswitch body;
a backlight module disposed under the membrane circuit board for emitting light to the symbol via the membrane circuit board; and
an elastic body disposed between the keycap and the membrane circuit board for returning the keycap to its original position, the elastic body having a first ring-shaped base, a second ring-shaped base, and a central pillar, the first ring-shaped base abutting against a position on the keycap outside the symbol and forming a first bridge structure extending to connect to the second ring-shaped base, and the second ring-shaped base being disposed on the membrane circuit board and forming a second bridge structure extending to connect to the central pillar, to make the central pillar suspended relative to the membrane circuit board.

4. The backlight keyswitch of claim 3, wherein the first bridge structure has a vertical bridge portion and an inclined bridge portion, the vertical bridge portion extends vertically downward from the first ring-shaped base, and the inclined bridge portion extends obliquely from the vertical bridge portion to connect to the second ring-shaped base.

5. The backlight keyswitch of claim 3, wherein the second ring-shaped base has at least one air escape hole to expel air inside the second ring-shaped base when the keycap is pressed to cause deformation of the second bridge structure.

6. The backlight keyswitch of claim 3, wherein the membrane circuit board has a switch, and the central pillar has a downward protruding pillar corresponding to the switch; when the keycap is pressed, the first bridge structure and the second bridge structure deform to make the downward protruding pillar press and trigger the switch.
